(19) United States
(12) Patent Application Publication
(10) Pub. No.: US 2012/0060639 A1
(43) Pub. Date: Mar. 15, 2012

(54) Fold Stopper for Folding Bike

(76) Inventor: Bill Huang, Changhua County (TW)

(21) Appl. No.: 12/880,103

(22) Filed: Sep. 12, 2010

(51) Int. Cl. G05G 5/06

(52) U.S. Cl. 74/527

(57) ABSTRACT

A stopper disposed for preventing a folded folding bike from moving is disclosed. The stopper includes an insert on a fork and a socket on a chain stay. The insert and socket are provided with a tapered end and a locking recess, respectively. When a folding bike is folded, it can be locked by inserting the tapered end into the locking recess.

### BACKGROUND OF THE INVENTION

1. Technical Field

The invention generally relates to folding bikes, particularly to mechanisms for stopping folded folding bikes.

2. Related Art

In recent years, riding bike has become really popular in the whole world. Riding bike is not only exercise but also family activity. Bicycles can be categorized into many different types, such as road bikes, mountain bikes and folding bikes.

A folding bike is a bicycle designed to fold into a compact form, facilitating transport and storage. When folded, the bikes can be more easily carried into buildings and workplaces or onto public transportation or more easily stored in compact living quarters or aboard a car, boat or plane. Folding mechanisms vary, with each offering a combination of folding speed, folding ease, compactness, ride, weight, durability and price. Usually, a folding bike is provided with a folding box in its frame to make it horizontally foldable.

However, conventional folding bikes tend to sway when folded because there are no stoppers. As a result, when a folded folding bike is being carried without stopping the frame, the bike may be damaged by percussion of components or it may be inconvenient when treating the bike. Thus, each folding bike should be provided with a stopper for fixing the folded frame.

### SUMMARY OF THE INVENTION

An object of the invention is to provide a stopper for a folding bike, which can stop a folded bike from sway.

To accomplish the above object, the stopper of the invention includes an insert on a fork and a socket on a chain stay. The insert and socket are provided with a tapered end and a locking recess, respectively. When a folding bike is folded, it can be locked by inserting the tapered end into the locking recess.

### BRIEF DESCRIPTION OF THE DRAWINGS

FIG. 1 shows a folding bike with the invention;

FIG. 2 is a perspective view of the first embodiment of the invention;

FIG. 3 is an exploded view of the insert;

FIG. 4 is an exploded view of the socket;

FIG. 5 is a cross-sectional view of the first embodiment before the insert enters the socket;

FIG. 6 is a cross-sectional view of the first embodiment while the insert is entering the socket;

FIG. 7 is a cross-sectional view of the first embodiment after the insert completely enters the socket;

FIG. 8 is an explode view of the second embodiment of the socket; and

FIG. 9 is cross-sectional view of the second embodiment of the invention.

### DETAILED DESCRIPTION OF THE INVENTION

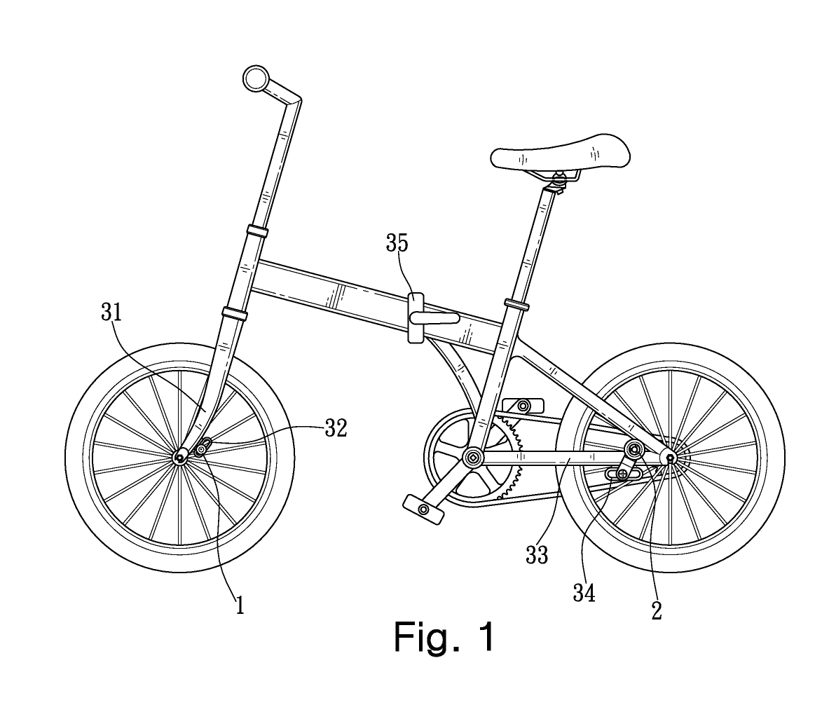

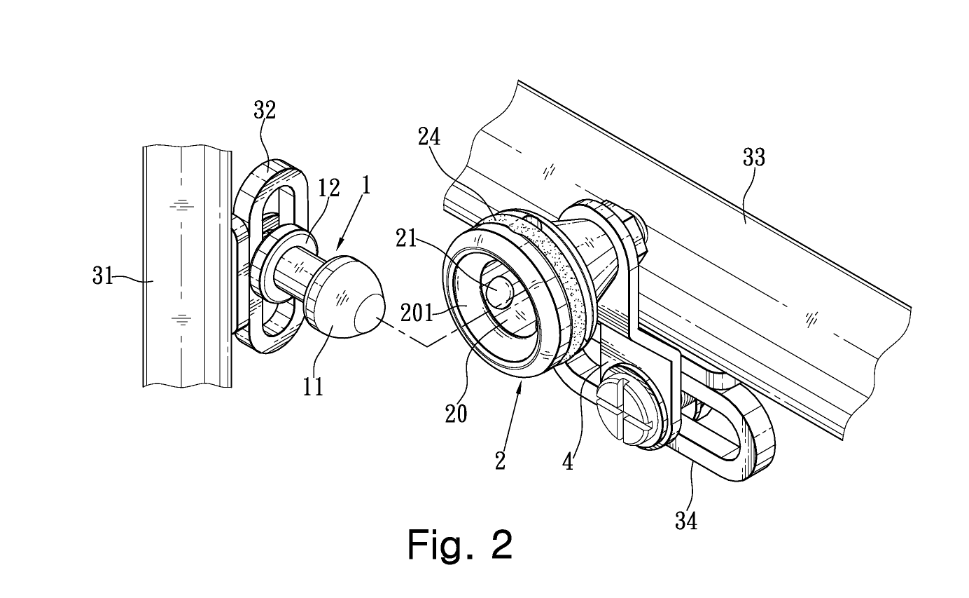

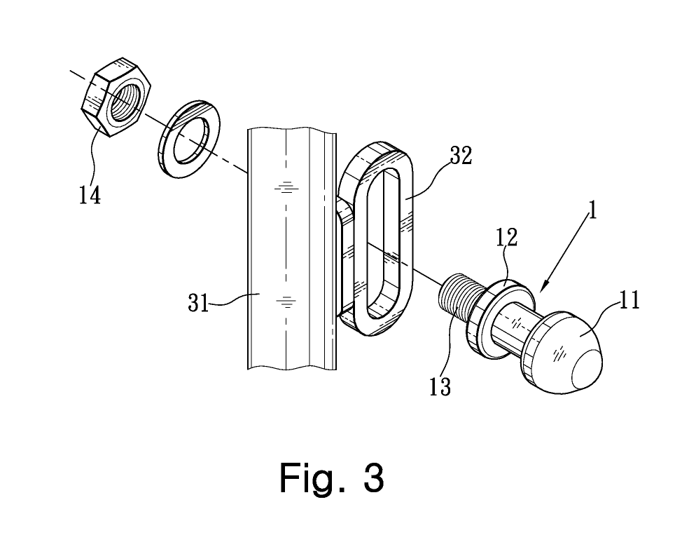

FIGS. 1 and 2 illustrate a preferable embodiment of the invention. The stopper includes an insert 1 and a socket 2. The insert 1 is mounted on a leg of a fork 31 of a folding bike 3. The insert 1 is provided with a tapered end 11. In the shown embodiment, the tapered end 11 is of a conic shape. The other end of the insert 1 is provided with a disk 12 and a threaded rod 13. As shown in FIG. 3, the threaded rod 13 can be inserted through a first slot seat 32 on the fork 31 and is screwed by a nut 14. The long slot seat 32 can provide an adjustment of position of the insert 1.

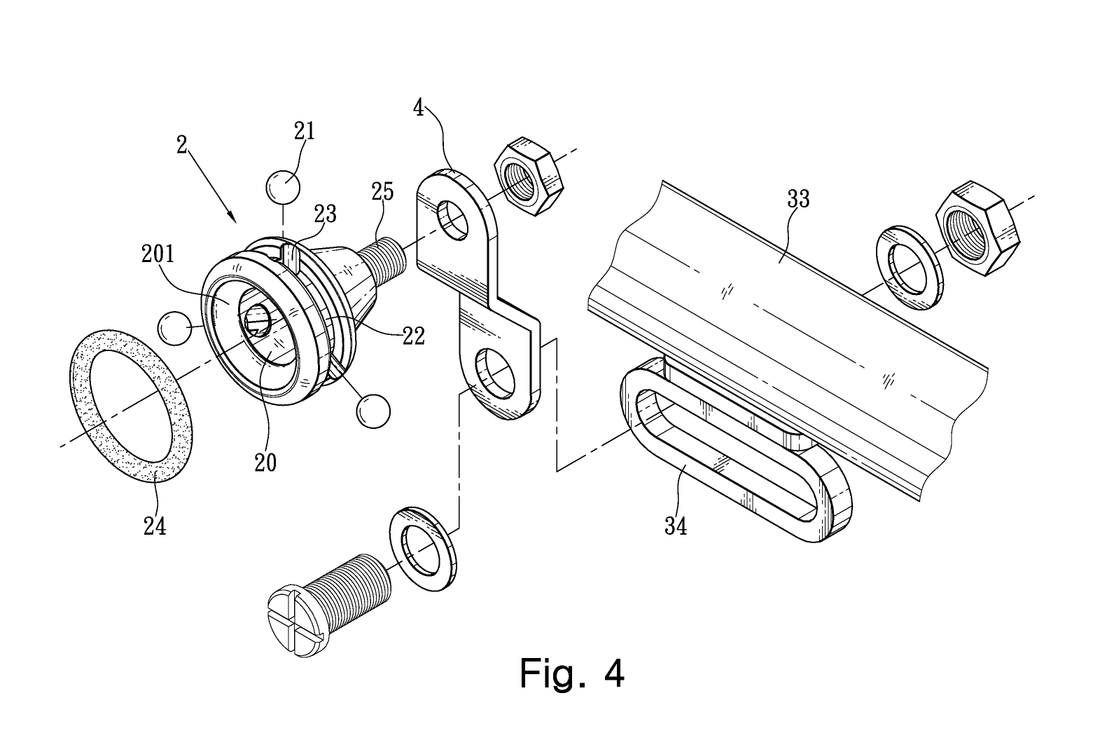

The socket 2 is mounted on a chain stay 33 of the folding bike 3. The chain stay 33 being mounted by the socket 2 and the leg of the fork 31 being mounted by the insert 1 are located on the same side of the folding bike 3. The socket 2 is provided with a locking recess 20. When the folding bike 3 is completely folded, the insert 1 can be automatically locked at the socket 2 by inserting the tapered end 11 into the locking recess 20. In the shown embodiment, the tapered end is right accommodated by the locking recess 20. A cup-like opening 201, which corresponds to the tapered end 11 in shape, is provided in the locking recess 20. Additionally, at least one protruding ball 21 is movably disposed on the wall of the opening 201. In the shown embodiment, an arrangement of three protruding balls 21 is preferred. Please refer to FIG. 4. An annular trough 22 is disposed around the outer surface of the socket 2. Three through holes 23 are radially disposed in the socket 2 and communicate with the annular trough 22. The protruding balls 21 are separately accommodated in the through holes 23. The protruding balls 21 protrude from the through holes 23 but cannot escape because the inner openings of the through holes 23 taper off slightly. And an O-ring 24 is put around the trough 22 for elastically covering the outer openings of the through holes 23, so that the protruding balls 21 are retractable. Additionally, a screw 25 is formed at an inner end of the socket 2. The screw 25 can be inserted into a bracket 4 to be fixed at a second slot seat 34 on the chain stay 33. Similarly, the position of the socket 2 can adjusted in the second slot seat 34.

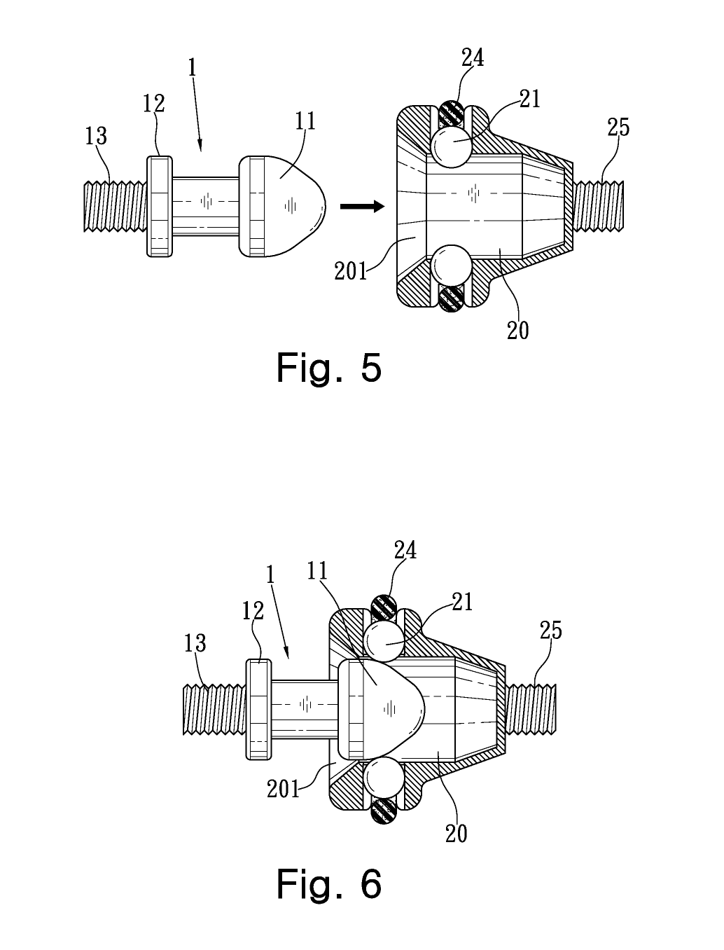

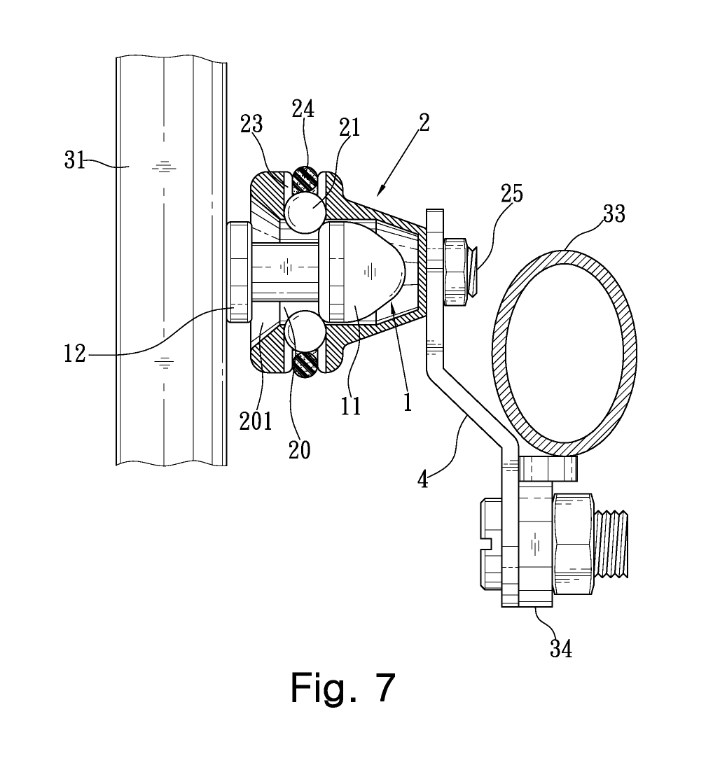

Please refer to FIGS. 5-7. Because the insert 1 and socket 2 are on the same side of the folding bike 3, the insert 1 can be inserted into the socket 2 when the folding bike 3 is completely folded. This can prevent the folded bike from swaying.

When the insert 1 is entering the locking recess 20 of the socket 2, the tapered end 11 is easy to embed. And the protruding balls 21 are pushed by the tapered end 11. The protruding balls 21 are pressed by the O-ring 24 to run back to resist the tapered end 11 once the tapered end 11 complete enters in the socket 2. That is, a locking status has been formed. When a user wants to release the lock formed by the insert 1 and socket 2, all he/she needs to do is to slightly apply a force to make the tapered end 11 escape from the socket 2.

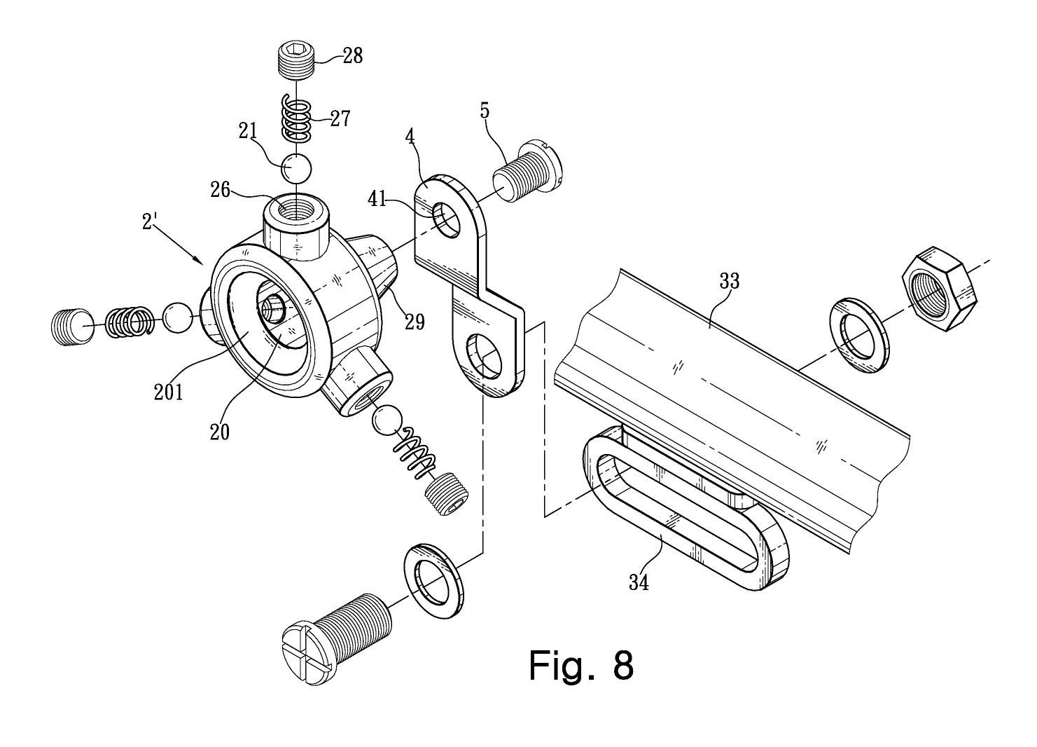

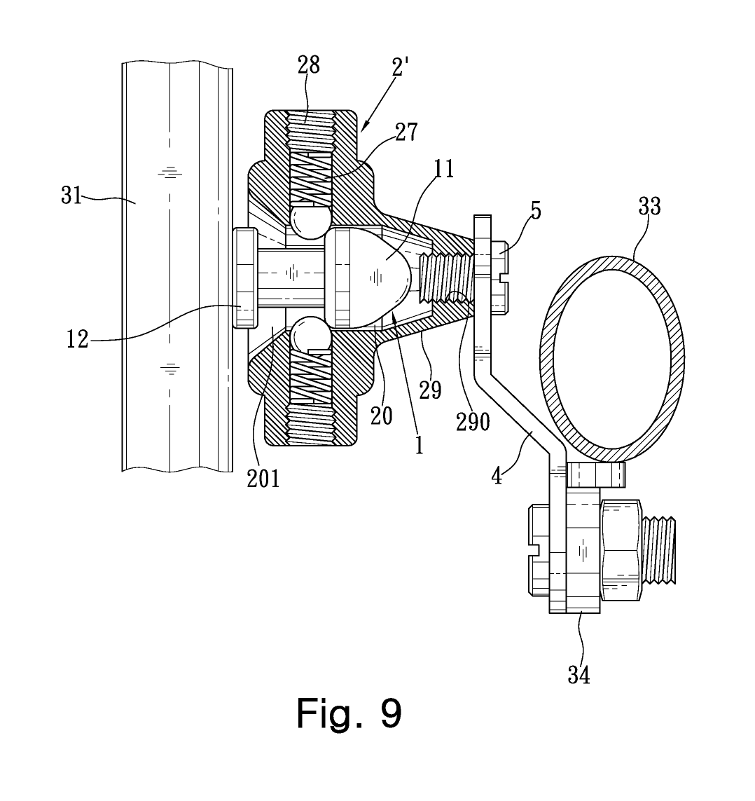

FIGS. 8 and 9 show another embodiment of the invention. In this embodiment, the outer ends of the through holes 23 are separately provided with threads 26. Each of the threads 26 is screwed by a nut plug 28. And a spring 21 is disposed between the nut plug 28 and the protruding ball 21 for elastically pushing the protruding ball 21. Additionally, a hole seat 29 is formed at the inner end of the socket 2′ for being screwed by a screw 5, so that the socket 2′ can be mounted at the second slot seat 34 through the bracket 4.

In sum, the invention can provide a lock function to a folded bike frame. When locked, the folded bike can be avoided swaying.

It will be appreciated by persons skilled in the art that the above embodiments have been described by way of example only and not in any limitative sense, and that various alterations and modifications are possible without departure from the scope of the invention as defined by the appended claims.

What is claimed is:

1. A stopper for a folding bike; comprising:
a insert mounted on a fork of the folding bike, and having a tapered end;
a socket mounted on a chain stay of the folding bike, and having a locking recess;
thereby the tapered end is inserted into the locking recess to form a locking status when the folding bike is completely folded.

2. The stopper of claim 1, wherein the tapered end is of a conic shape.

3. The stopper of claim 1, wherein an inner end of the insert is provided with a disk and a threaded rod, and the threaded rod is inserted through a first slot seat on the fork and is screwed by a nut.

4. The stopper of claim 1, wherein a cup-like opening, which corresponds to the tapered end in shape, is provided in the locking recess.

5. The stopper of claim 4, wherein a one protruding ball is retractably disposed in a through hole radially disposed in the socket, and the protruding ball protrudes from the cup-like opening.

6. The stopper of claim 5, wherein an annular trough is disposed around an outer surface of the socket and communicates with the through hole, an inner openings of the through hole tapers off to allow the protruding ball protrude from the through hole but cannot escape, and an O-ring is put around the annular trough for elastically resisting the protruding ball.

7. The stopper of claim 1, wherein a screw is formed at an inner end of the socket.

8. The stopper of claim 5, wherein the outer ends of the through hole is provided with a thread, the thread is screwed by a nut plug, a spring is disposed between the nut plug and the protruding ball for elastically pushing the protruding ball.

9. The stopper of claim 1, wherein a hole seat is formed at the inner end of the socket.
